(19) United States
(12) Patent Application Publication
(10) Pub. No.: US 2003/0222000 A1
(43) Pub. Date: Dec. 4, 2003

(54) Cleaning system for animal litter and bedding

(76) Inventor: William Opfel, Mesa, AZ (US)

Correspondence Address: Kenneth C. Booth, Schmeiser, Olsen & Watts LLP, 18 East University Drive, #101, Mesa, AZ, 85201, US

(21) Appl. No.: 10/188,611

(22) Filed: Jul. 2, 2002

Related U.S. Application Data
(60) Provisional application No. 60/371,783, filed on Apr. 10, 2002.

(51) Int. Cl. B07B 4/00

(52) U.S. Cl. 209/139.1; 209/143

(57) ABSTRACT

A cleaning system is disclosed for cleaning contaminants from animal litter. In a first embodiment of the invention, a vacuum and a blower are coupled together and configured so that the blower blows a first fluid stream into animal litter simultaneous with the vacuum drawing a second fluid stream from the animal litter. Relatively light contaminants are drawn into the vacuum while the relatively heavy animal litter is left behind. In a second embodiment of the invention, a cyclonic separator is used to draw the animal litter and the intermixed contaminants into the cyclonic separator simultaneously, and separate the animal litter from the contaminants. The animal litter is returned to the area from which it was removed. The embodiments of the invention have particular use in cleaning horse stalls to separate the horse bedding from the allergens which collect in the horse bedding over time and present health risks to the horse, and return the horse bedding for continued use. Embodiments of the invention prolong the usefulness of the horse bedding, promote a healthy environment for the horse, and reduce the overall maintenance and health care costs for the horse.

### BACKGROUND OF THE INVENTION

1. Technical Field

This invention generally relates to a method and apparatus for cleaning animal litter for reuse, and more particularly to cleaning allergens, germs and other light-weight contaminants from animal litter and bedding.

2. Background Art

Animal litter, also called animal bedding in the large animal industry (collectively referred to herein as “litter”), is a common hiding place for many allergens such as animal hair and fur, dander, dust mites, dust, dirt, protein from decomposing animal feces, and the like, and for germs such as bacteria, viruses and fungi, and the like. Allergens and germs can be a problem not only for the animal using the litter, but for the care givers of the animal. Both the animal and the care giver may develop respiratory ailments and diseases, hair loss, rashes and the like from common allergens and germs present in the animal litter. Horse stalls are typically overwhelmed with as much as 15-30 gallons of urine and 10-50 pounds of manure per day. While much of the obvious animal waste can be removed directly from the horse bedding, portions of the animal waste, and the smaller allergens and germs can not. The present solution to the problem of allergens, germs and other contaminants is to remove the contaminated bedding and replace it with new bedding frequently. While this approach is effective, it can also be expensive to dispose of the contaminated bedding materials, and to use new bedding in the stall frequently. Typically, bedding materials are replaced daily, weekly or monthly to remove the contaminants. There is presently no known system available for easily separating the contaminants from the bedding to enable the litter to be reused without the contaminants.

### DISCLOSURE OF THE INVENTION

A first aspect of the present invention relates to a system for removing allergens and other contaminants from animal litter by stirring up the relatively heavy animal litter to gain access to and loosen relatively light contaminant material for removal from the litter. As used herein, the term “litter” and “animal litter” is considered to be interchangeable with the terms “bedding” and “animal bedding”. In the small animal industry, for example the cat industry, the terms “litter” and “animal litter” are commonly used to refer to the material on which the animal urinates or defecates. In the large animal industry, and particularly the horse industry, the convention is to use the terms bedding and animal bedding rather than litter and animal litter. This may be because the large animals often sleep in the area in which the animal litter is placed. Despite the difference in term usage in different industries, to simplify use for the purposes of this disclosure which relates to animal litter for animals of all sizes, the term “litter” is intended to encompass “bedding”, and “litter” may be used interchangeably with “bedding.”

A second aspect of the present invention relates to removing germs such as bacteria, viruses, fungi and other microbal contaminants from animal litter by exposing the litter to ultraviolet energy. In a first embodiment of the invention, a blower for producing a fluid stream from a cleaning system and a vacuum for producing a fluid stream into the cleaning system are used simultaneously. The blower is configured to blow a first fluid stream, such as an air stream, toward an animal litter target to be cleaned with enough force to raise the animal litter from the surface on which it lays into temporary suspension in the first fluid stream. The vacuum is configured to simultaneously draw a second fluid stream into the cleaning system from the region of the target material with enough force to draw the material in and around the animal litter, which is lighter than the animal litter, from the fluid stream in which the animal litter is temporarily suspended. The second fluid stream may then be filtered, for example with a cleanable cloth bag filter, to remove any contaminants from the second fluid stream. Specific embodiments relating to the first embodiment of the invention may include a fluid stream deflection plate or other enclosed shroud to control contamination being blown away to the surrounding environment by the blower fluid stream. In accordance with the second aspect of the invention, an ultraviolet source is provided at or near the target material and directed toward the suspended animal litter to destroy germs exposed to the light.

In a second embodiment of the invention, a vacuum for producing a fluid stream into a cleaning system is used to draw a stream of animal litter and contaminants from an animal stall, or other area to be cleaned, into the cleaning system. The fluid stream is then drawn through a separation chamber, such as a cyclonic or other separator, to separate the relatively heavier animal litter from relatively lighter contaminants. The animal litter is then returned to the stall from which it was removed, or are stored until cleaning is complete and then returned to the stall. The contaminants are drawn away from the animal litter and are filtered from suspension in the fluid stream. Specific embodiments relating to the second embodiment of the invention include a separation chamber configured with one or more straps for a user to carry, configured with wheels for a user to roll between locations to be cleaned, and larger configurations to be carried on or behind a truck. In accordance with the second aspect of the invention, an ultraviolet light source is directed at the stream of animal litter at some point within the system to destroy germs exposed to the light.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a side view of an animal litter cleaning system configured according to the first embodiment of the present invention;

FIG. 2 is a side view of an animal litter cleaning system with a fluid stream deflection plate configured according to the first embodiment of the present invention;

FIG. 3 is a perspective view of the deflection plate of the embodiment of FIG. 2;

FIG. 4 is a perspective view of an enclosed shroud for use in restricting blow-away contaminants according to an embodiment of the invention;

FIG. 5 is a side view of the air stream nozzles of the first embodiment of the invention illustrating how they separate the animal litter from the contaminants;

FIGS. 6a and 6b are side views of configurations of the air stream nozzles of the first embodiment of the invention with the blower nozzle angled and a deflection plate included to enhance separation of the contaminants from the animal litter;

FIG. 7 is a side view of the air stream nozzles of the first embodiment of the invention illustrating air flow within an enclosed shroud;

FIG. 8 is a view of the second embodiment of the invention including a cyclonic separation chamber; and

FIG. 9 is a side view of a more complex embodiment of the invention with multiple separation process levels.

### DETAILED DESCRIPTION OF EMBODIMENTS OF THE INVENTION

As discussed above, embodiments of the present invention relate to a cleaning system for removing contaminants from animal litter. As used herein, contaminants are specifically intended to include such materials as dust, dirt, sand, hay, feed, hair, fur, dander, dust mites and other small pests, proteins from decomposing animal feces, pollen, mold spores, germs, other debris which is typically wind-blown, other common allergens and risks for respiratory infections and diseases, and the like (hereinafter “contaminants”). As used herein, germs are specifically intended to include living microbal contaminants such as bacteria, viruses, fungi, and the like (hereinafter “germs”). Through the use of embodiments of the present invention, contaminants may be removed from animal litter to protect the animal and to extend the useable life of the litter.

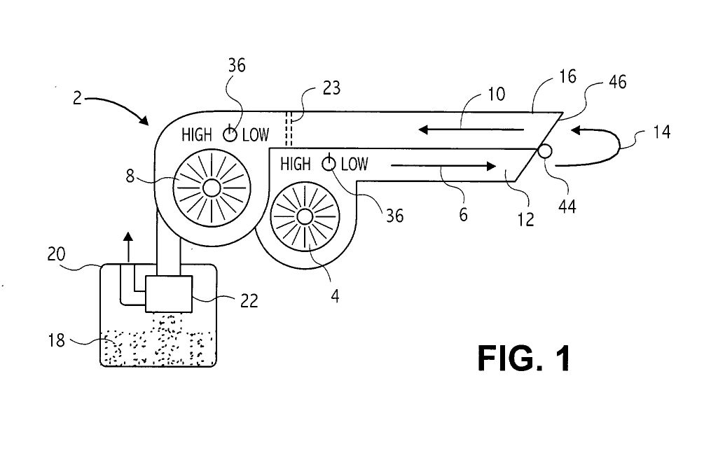

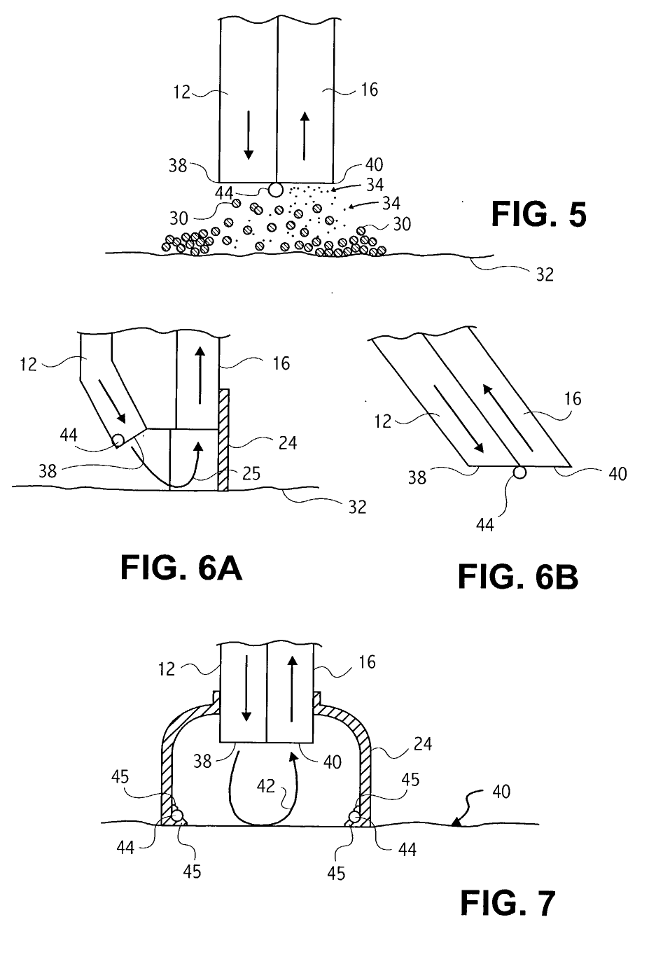

FIG. 1 illustrates a first embodiment of the cleaning system 2 of the invention which includes a blower motor 4 producing a first fluid stream in the direction of first arrow 6, and a vacuum motor 8 producing a second fluid stream in the direction of second arrow 10. When the first fluid stream exits the blower nozzle 12 and comes in contact with a contaminated animal litter (see FIG. 5), at least a portion of the first fluid stream joins the second fluid stream, traveling in the direction of third arrow 14, carrying contaminants from the animal litter into the vacuum nozzle 16 in the direction of the second arrow 10. The vacuum nozzle 16 carries the contaminants 18 to a storage bag 20. In a particular configuration, the storage bag 20 is a cleanable cloth storage bag 20 which filters the contaminants from the second fluid stream by passing the second fluid stream through one or more walls of the cloth storage bag. Additionally, the storage bag 20 may include one or more separation devices 22 to separate the contaminants 18 from the fluid stream. Appropriate separation devices 22 to clean an air stream of contaminants are well known in the art and are commonly used with vacuum products. Examples of air separation devices 22 include, but are not limited to, mesh filters, water filters and bubblers, cyclonic separators, and the like. An additional filter 23 and/or blade may be included in line with the vacuum nozzle 16 to filter any animal litter inadvertently drawn into the air stream and/or to chop up larger contaminants such as hay or animal hair drawn into the fluid stream. An optional ultraviolet light 44, as explained further in reference to FIGS. 5-7, may be included near the distal end 46 of the nozzles to destroy germs on and around the animal litter. The motors 4 and 8 may be powered by any power source known in the art. Examples of conventional power sources include gas and electric.

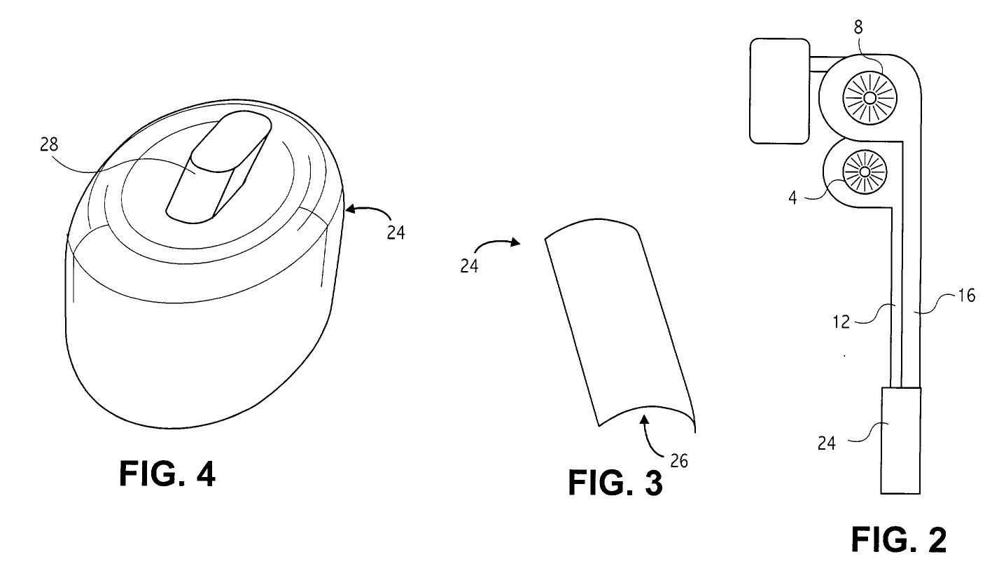

FIG. 2 illustrates the first embodiment of the invention having a blower motor 4 blowing a first fluid stream through the blower nozzle 12 and a vacuum motor 8 drawing a second fluid stream through the vacuum nozzle 16, but also including a shroud 24 configured as a deflector plate at least partially surrounding the distal opening to the vacuum nozzle 16. The shroud 24 may be of any shape configured to encourage air flow toward the vacuum nozzle 16 opening. The shroud 24 may, as shown in FIG. 2, also extend at least partially around the distal opening to the blower nozzle 12 to further encourage air flow to the vacuum nozzle 16. FIGS. 3 and 4 illustrate two exemplary embodiments of shrouds 24 for use with the invention.

The first exemplary embodiment of the shroud 24 shown in FIG. 3 is an arcuate embodiment which fits over the vacuum nozzle 16, extending beyond it. The shroud 24, if formed separate from the vacuum nozzle 16, may be attached to the vacuum nozzle 16 with an internal surface 26 of the shroud 24 which either closely resembles the arcuate shape of the vacuum nozzle 16 or which is bendable to form to the shape of the vacuum nozzle 16 is against the vacuum nozzle. The shroud 24 in such a configuration could be coupled to the vacuum nozzle 16 with an adhesive, straps, screws, by molding the shroud 24 to tightly fit over the vacuum nozzle 16 and be held in place by friction, or by any other means known in the art for coupling the materials of which the vacuum nozzle 16 and shroud 24 are made. Alternatively, the shroud 24 may be formed as part of the vacuum nozzle 16, the blower nozzle 12 or, in particular configurations, both the vacuum nozzle 16 and the blower nozzle 12. It is contemplated that the vacuum nozzle 16, the blower nozzle 12 and the shroud 24 may be formed, for example, of a plastic, a nylon, a metal, or a mixture thereof. Methods of forming and molding plastics and metals are well known in the art.

The second exemplary embodiment of the shroud 24 shown in FIG. 4 is a partially enclosed embodiment which includes an angled opening 28 in the top for receiving both the vacuum nozzle 16 and the blower nozzle 12 therethrough. The shroud 24 opening 28, like the arcuate deflection plate shroud 24, may be coupled to the vacuum nozzle 16 and blower nozzle 12 by any known methods, or may alternatively be formed as part of the blower and vacuum nozzles 12 and 16. The bottom of the shroud 24 is open and provides access to the animal litter (see FIG. 7). Use of an enclosed shroud 24 reduces the likelihood that contaminants will be blown into the air or to surrounding areas when the animal litter is being cleaned.

FIG. 5 illustrates the use and operation of the first embodiment of the cleaning system with a germicidal light. A fluid, such as air, is blown from the blower nozzle 12 into animal litter 30 to be cleaned. The blown air is of sufficient force to lift the animal litter 30 from a surface 32, and allow the litter 30 and contaminants 34 to be suspended above the surface 32 within a turbulence zone. The exact blowing power of the blower nozzle 12 needed depends, among other factors, upon the weight of the animal litter 30 and the distance of the blower and/or vacuum nozzles from the ground. Although other blower power applications are certainly contemplated for various weights of animal litter, for a hand-held model, a 1-2 horsepower (HP) blower motor appears to work well for an animal litter having a granule size of approximately 4-20 mesh and an animal litter density of approximately 20-70 lbs/ft³. An appropriate animal litter and horse bedding having these properties may be obtained through Equidry Bedding Products, LLC in Mesa, Ariz. It is contemplated that the cleaning system may be used on animal litters having a density even as high as 150 lbs/ft³ or more. For particular litter densities, mesh sizes and weights, other power level configurations, or even adjustable power blowers may also be used. For example, FIG. 1 shows an optional blowing/vacuuming power adjuster knob 36 to adjust the blowing and/or vacuum power between a low power and a high power.

A germicidal light 44, such as that described with reference to FIG. 1, may be included near the distal end of the cleaning system so that at least the animal litter 30 and perhaps also the contaminants 34 are exposed to the energy from the light 44 when the animal litter 30 is suspended above the surface. Germicidal lights are currently available, for example, from Atlantic Ultraviolet Corporation of Hauppauge, N.Y. for use in air duct disinfection systems, and may readily be adapted by one of ordinary skill in the art for use with embodiments of the present invention. Atlantic Ultraviolet Corporation has found that by emitting ultraviolet energy toward a surface, a large majority of the energy having a wavelength which is at the mercury resonance line of 254 nanometers, germs such as virus, bacteria and mold spores can be destroyed with as high as 98% effectiveness. By exposing the animal litter 30 to germicidal light while it is suspended above the surface, more of each animal litter 30 granule spinning due to turbulance will be exposed to the light, more germs will be destroyed, and the animal litter will be cleaner. To ensure that the ultraviolet energy is emitted only toward the animal litter to be cleaned, directional baffels or containment shields (FIG. 7) may be used.

A fluid stream including air and contaminants 34 is drawn into the vacuum nozzle 16 to separate the animal litter 30 from the contaminants 34 by gravity separation. The vacuum power is of sufficient force to draw the contaminants 34 into the vacuum nozzle 16, but of a force insufficient to draw any appreciable amount of animal litter 30 into the vacuum nozzle 16. The exact vacuum power of the blower nozzle 12 depends upon the weight of the animal litter 30 and the weight of the contaminants 34 to be cleaned from the animal litter 30. Although other vacuum power applications are certainly contemplated for various weights of animal litter, for a hand-held model, a 1-2 HP vacuum motor appears to work well for the animal litter described above having a granule size of approximately 4-20 mesh and an animal litter density of approximately 20-70 lbs/ft³, though greater densities are contemplated. For particular litter densities, mesh sizes and weights, other power level configurations, or even adjustable power vacuums may also be used. For applications where greater quantities or weights of materials need to be cleaned at one time, greater vacuum and/or blower powers may be used.

Due to the difference in the respective weights and densities of the animal litter 30 and the contaminants 34, after the blower causes the animal litter 30 and the contaminants 34 to be lifted from the surface 32 and be mixed with the fluid flow from the blower nozzle 12 to the vacuum nozzle 16, the contaminants 34 are drawn by the fluid flow and the animal litter 30 drops to the surface 32. Some manual adjustment may also be made by moving the distal ends 38 and 40 of the blower and vacuum nozzles 12 and 16 nearer to and farther away from the animal litter 30 and contaminants 34. As the distal ends 38 and 40 move nearer to the materials 30 and 34, the effect of the blower and vacuum on the materials 30 and 34 is increased. As the distal ends 38 and 40 are moved farther away from the materials, the effect is decreased. In this way, a user of the cleaning system can adjust to and find an optimal blowing and vacuum power for the particular animal litter and contaminants used, in part, by adjusting the distance of the nozzle end from the animal litter. Particular embodiments of the invention may also include an adjustable shroud to assist a user in gauging how far away the nozzle end should be for particular grades or classifications of animal litter. For example, a shroud setting which extends the shroud 12 inches from the nozzle end may be appropriate for animal litter having a size between 14-30 mesh, while a setting which extends the shroud only 8 inches from the nozzle end may be appropriate for the heavier animal litter having a size between 4-20 mesh. The desired settings may also be affected by the angle at which a user holds the system with respect to the ground. Because of the many possible combinations, each user may need to adjust the shroud as suits the user for the particular animal litter to be cleaned and the user's personal cleaning style.

FIGS. 6a and 6b illustrate embodiments of the invention comprising a blower nozzle 16 angled to increase the disruption of the animal litter by the blowing fluid stream. In FIG. 6a, a cut-away of a shroud 24 illustrates that the shroud 24 further enhances the collection of dust and other allergens from the animal litter. In FIG. 6a, the blower nozzle 12 is directed to blow into the animal litter at an angle other than parallel to the vacuum nozzle. This may allow the blown fluid stream to better lift the animal litter and contaminants, and direct the contaminants into the fluid stream, and may also result in some cyclonic spinning of the materials in the direction of arrow 25 to enhance separation within the turbulence zone. In FIG. 6b, both the blower and vacuum nozzles 12 and 16 are formed so that when the distal ends 38 and 40 are placed parallel to the ground, the blower and vacuum nozzles 12 and 16 are at an angle other than perpendicular to the ground (shown in FIG. 6b as approximately 45°). The germicidal light 44 is also shown just inside the distal end 38 of the blower nozzle 12 directing the ultraviolet energy therefrom toward the surface 32 and the shroud 24. This will assist in focusing the energy on the target area to limit or prevent outside exposure to the ultraviolet energy.

FIG. 7 illustrates an enclosed shroud 24 configuration. The arrow 42 from the blower nozzle 12 to the vacuum nozzle 16 represents the fluid stream flow within the shroud 24. Without an enclosure about the area around the nozzle ends 38 and 40, some contaminants may be blown away from the vacuum nozzle end 40 rather than being suspended in the fluid stream and drawn into the vacuum nozzle 16. Materials which are blown away may contaminate the air or other regions which have already been cleaned. By placing an enclosed shroud 24 around the area, it is much less likely that contaminants will be blown away from the vacuum nozzle 16. Additionally, the use of an enclosed shroud 24 enhances the effectiveness of the blower and vacuum by containing the turbulence zone therein. Because the respective energies of the blower and vacuum are focused within the limited volume of the enclosed shroud 24, separation effectiveness is increased. As a result, lower blower and vacuum pressures may be used than without an enclosed shroud.

It will be clear to those of ordinary skill in the art that the lower opening of the enclosed shroud may be of any shape and volume to contain the turbulence region and enhance separation of contaminants from the litter, such as, for example, rounded, oval, rectangular, square, and the like. While the upper region of embodiments shown in FIGS. 4 and 7 illustrate a domed upper region, it will be understood that any shape may be used such as, for example, boxed, conical and pyramidal. The dimensions of the lower opening of the enclosed shroud 24 may be of any dimensional size which is larger than the combined dimensional opening size of the openings for the blower and vacuum nozzles. However, a size of approximately 2 to 20 times larger is desirable to maximally enhance the turbulence region. For example, if the combined openings dimensions are 3″×6″, an enclosure opening of between 6″×12″ to 21″×42″ may be desired, though proportional enlargements are not required or necessarily desirable. More particularly, a dimensional size between approximately 3 to 10 times that of the combined nozzle openings provides an easily maneuverable unit with an adequate turbulence region. The specific shape, dimensions and volume of an optimal turbulence region within the enclosed shroud will depend upon the vacuum and blower powers, the distance of the nozzle openings from the ground, the weight and size of the animal litter, and the angle and location at which the blower nozzle enters the shroud. One of ordinary skill in the art will readily be able to determine an appropriate shape, dimensions and volume for a shroud of a particular cleaning system without undue experimentation from the explanation provided herein.

The connection between the enclosed shroud 24 and the blower and vacuum nozzles 12 and 16 may further be made adjustable to allow the distance between the distal ends 38 and 40 of the nozzles and the animal litter 44 to be adjusted depending, among other factors, upon the power of the vacuum and blower, and the weight and/or density of the animal litter to be cleaned.

One or more germicidal lights 44 may also be included within the shroud 24 to destroy germs on and among the animal litter within the shroud. By placing the lights 44 within the shroud 24, and perhaps by even including direction and protection plates 45, the exposure regions for ultraviolet light energy may be limited to specific regions within the shroud 24. A coating may optionally be placed on the inner surface of the shroud 24 or on portions of the lights 44 to absorb ultraviolet energy contacting the surface to prevent reflection to areas outside the shroud 24 or to direct the energy emitting from the lights 44.

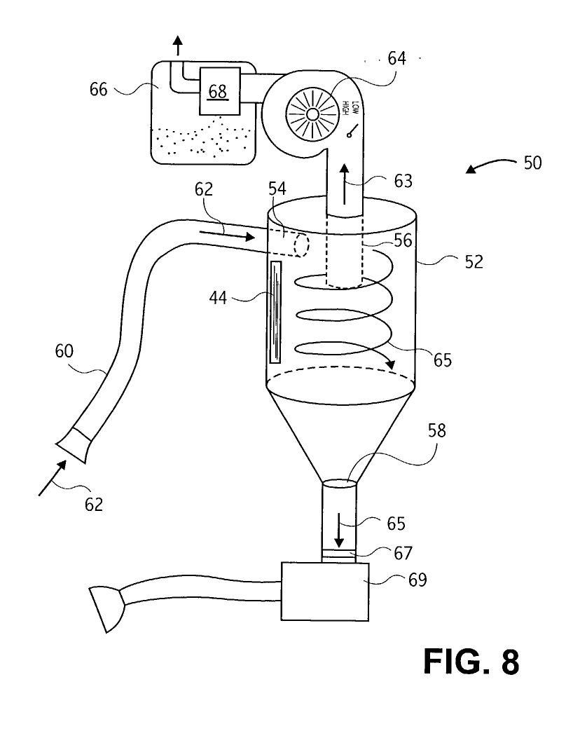

FIG. 8 illustrates a configuration of a second embodiment of the cleaning system 50 of the present invention including a cyclonic separator to separate the animal litter from the contaminants. The cyclonic separator creates an air turbulence region within the separator for separation of the contaminants from the animal litter. Cyclonic separators for use with vacuum cleaners are well known in the art. Examples of particular patents which describe the general nature and operation of cyclonic separation, particularly for its use in a household vacuum cleaner include: U.S. Pat. No. 6,350,292 to Lee et al. (issued Feb. 26, 2002), U.S. Pat. No. 6,344,064 to Conrad (issued Feb. 5, 2002), and U.S. Pat. No. 6,261,330 to Dyson et al. (issued Jul. 17, 2001), the disclosures of which are hereby incorporated herein by reference. Cyclonic separation used in a vacuum cleaner, however, is designed to separate dust and allergens from an air stream for disposal of the dust and allergens and release of a filtered air stream to the environment. Conventional vacuum cleaners are not designed to remove contaminants from loose granular materials.

Configurations of this second embodiment of the present invention include a cyclonic separator 52 which has a fluid stream inlet 54, a fluid stream outlet 56 and an animal litter outlet 58. Using the basic principles of cyclonic separation, a fluid stream, which comprises both relatively light contaminants and relatively heavy animal litter is drawn into the cyclonic separator 52 through a vacuum hose 60 in the direction of arrow 62. The vacuum hose 60 leads to the cyclonic separator 52 and enters the separator 52 near a wall of the separator 52. The fluid stream initially flows around the fluid stream outlet 56 of the cyclonic separator 52 in the direction of arrow 65. The animal litter is separated from the contaminants by cyclonic separation (also called centrifugation in the art). The animal litter granules are forced closer to the walls of the cyclonic separator 52, and the contaminants are forced toward the axial center of the cyclonic separator 52. The contaminants which move closer to the axial center of the cyclonic separator 52 are drawn into the outlet 56 in the direction of fluid stream arrow 63 by the vacuum created there by vacuum motor 64.

The vacuum motor 64 provides enough vacuum to draw the animal litter through the vacuum tube 60 to centrifugally separate the animal litter from intermixed contaminants within the cyclonic separator 52. Alternatively, a blower motor could be provided in line with vacuum tube 60. The precise power of the vacuum/blower motor depends upon the weight and/or density of the animal litter and contaminants, but may be readily calculated by those of ordinary skill in the art. The vacuum motor 64 passes the fluid stream into a collection bag 66. To clean the air passing from the collection bag, additional filtering may be performed by an additional filter 68. The additional filter 68 may be placed prior to or after the vacuum motor 64 and may be of any variety known in the art, including, but not limited to, those filters commonly used in the vacuum art to remove dust and dirt such as mesh filters, cyclonic filters, water bubbling filters, and the like. The clean animal litter drops to the bottom of the cyclonic separator 52 and exits the cyclonic separator 52 through the animal litter outlet 58. As the animal litter continues cyclonic rotations around the separator housing toward the bottom of the housing where it narrows, there is further separation due to the reduced radius of rotation.

An airlock valve 67, such as a simple rubber boot or a burp valve, is used to maintain pressure within the cyclonic separator 52. More complex embodiments may include passive or active systems for maintaining the vacuum pressure within the chamber while permitting the animal litter to pass from the cyclonic separator 52. An optional blower motor 69 is further included to force the animal litter through the output nozzle. The blower motor 69 is particularly helpful in embodiments where the cyclonic separator 52 is not positioned near the area being cleaned. The clean animal litter may be returned to the area from which it was removed, or may alternatively be stored for a time to allow for additional cleaning of the area before the animal litter is returned.

For example, to clean a horse stall using a configuration of this second embodiment of the invention, the vacuum motor 64 is turned on and draws a fluid stream through the vacuum hose 60. The vacuum hose 60, with the vacuum applied, draws the horse bedding, for example that manufactured by Equidry Bedding Products, LLC of Mesa, Ariz., having an approximate density of between 20-70 lb/ft³, from the horse stall into the cyclonic separator 52 along with all of the intermixed contaminants. The heavy horse bedding is separated from the relatively light contaminants by the separator 52. The light contaminants are drawn through the outlet 56, and stored for disposal. The heavy horse bedding may be placed back into the stall after it is clean, or may be placed into the stall simultaneous with cleaning other parts of the stall. A blower motor 65 is included near the outlet 58 to maintain the necessary vacuum pressure within the separator 52 and to assist the animal bedding in moving back to the stall.

It should be noted that many animal litters are not hard enough to withstand a cyclonic separation process and would be broken up and otherwise degraded by it. Those of ordinary skill in the art will understand and be able to determine the hardness required based upon the particular cyclonic separator and vacuum and blower pressures used. The horse bedding products available through Equidry Bedding Products, LLC of Mesa, Arizona (“Equidry”) typically have a hardness rating based upon a LA Abrasion test value of less than 40 (and more particularly less than 30) using modified mesh sizes for the smaller granule size of horse bedding, and are sufficiently hard to withstand a cyclonic separator process. Increasing hardness, however, may significantly reduce the absorptive capacity and rate of the animal litter in undesirable ways. Those of ordinary skill in the art will understand the benefits and trade-off of hardness and absorbency in animal litter.

Particularly useful animal litters for use with the present invention are those having an absorption capacity of approximately 0.5 ml/g to approximately 2.5 ml/g, or more specifically approximately 1.4 ml/g to approximately 1.9 ml/g. High absorbency is achieved as a result of porosity enhancing techniques and the resulting microporosity and macroporosity of the animal litter granules. The combination of external surface area and internal porosity surface areas can lead to very large lab-calculated surface areas. Animal litter compositions particularly useful with the invention may have a surface area of approximately 2,000,000 ft²/ft³ to approximately 40,000,000 ft²/ft³, or even up to approximately 75,000,000 ft²/ft³ if acid activated or bloated by kilning. Approximate examples of surface areas of gravel, sand, diatomaceous earth, and Equidry animal bedding are illustrated in the following table for comparison:

| | | Diatomaceous | Equidry |
|---|---|---|---|
| Gravel | Sand | Earth | Animal Bedding |
| 600 ft²/ft³ | 1500 ft²/ft³ | 200,000 ft²/ft³ | 2,000,000-75,000,000 |
| | | | ft²/ft³ |

An absorbency rate is a measure of the speed of movement of water (water front) as it is absorbed into a material. A wicking test was performed on two samples of Equidry animal bedding by allowing water from a water bath to climb the animal bedding composition in a standard, plastic, 52 mm inside diameter, 500 ml, graduated PolyLab™ cylinder, or column as is known in the art. Water enters the column through perforations in the base of the column. The perforations are of sufficient size and number to allow water from the bath to enter in the column, but not allow material to fall into the water bath. The wetting front in the material rises over time and is then plotted as distance versus time. A first animal bedding sample having granule sizes ranging from between 8 mesh to 20 mesh had an absorbancy rate of approximately 90 milliliters or more within 10 minutes. A second animal bedding sample having granule sizes ranging from between 20 mesh to 50 mesh had an absorbancy rate of approximately 105 milliliters or more within 90 seconds.

Accordingly, animal litter with superior absorbency and wicking, and sufficient hardness to not become significantly crushed during the cleaning process are most desirable for use with embodiments of the present invention. If the animal litter is too soft, it will become broken and turned to powder within the turbulence zone. If the animal litter lacks absorption capacity or absorbs too slowly, it is less useful as animal litter.

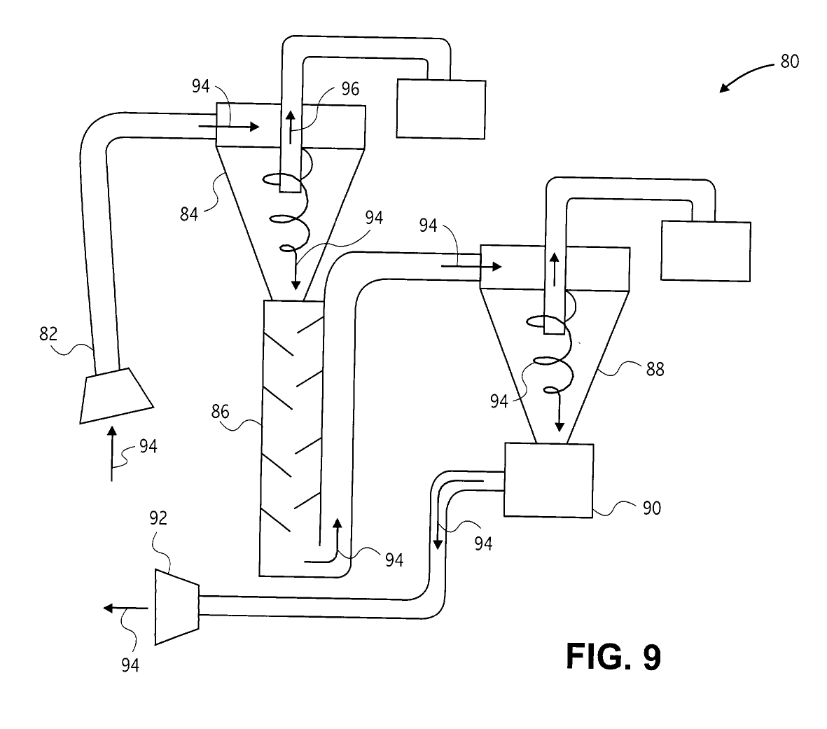

FIG. 9 illustrates a more complex embodiment of an animal litter cleaning system 80 having multiple separation levels for more fully cleaning contaminants and germs from animal litter. This particular embodiment includes an intake nozzle 82, a first cyclonic separator 84, an air aspirator 86, a second cyclonic separator 88, a blower 90 and an output nozzle 92. Animal litter travels through the system in the direction of arrows 94. In each separator or aspirator, additional separation of contaminants from the animal litter is obtained. The operation of cyclonic separators 84 and 88 is similar to and has been described with relation to previous separator embodiments. For the air aspirator 86, at the end of each baffle, where the ends of the baffles cross, is an air turbulence area to assist in separation of contaminants from the animal litter traveling through the turbulence area. In the region under each baffle additional turbulence occurs causing further separation. Contaminants separated from the animal litter travel in the direction of arrows 96. Each cyclonic separator 88 includes its own vacuum/blower motor for drawing the animal litter to be cleaned into the separator and separating the contaminants from the animal litter.

In operation, the intake nozzle 82 is passed over and through animal litter to be cleaned. The vacuum pressure associated with the system 80 is sufficient to draw the animal litter into the first separator 84 which separates loose contaminants from the litter before the litter is passed down through the baffels of the gravity agitator 86 to ensure all contaminants are loosened. The animal litter is then passed through the second separator 88 to remove any contaminants remaining in the animal litter. The blower 90 is configured to produce a positive pressure sufficient to return the animal litter to the location from which it was taken. It will be understood by those of ordinary skill in the art that more simple embodiments of the invention may be configured to be light and small enough for a user to carry on the user's back or shoulder. More complex embodiments, however, due to size and/or weight considerations, may be placed on a structure having wheels to be pulled by a user for use adjacent to a target area to be cleaned, or may be drawn or carried by a motored vehicle such as a truck, a tractor or a smaller vehicle such as an all-terrain vehicle (commonly called an ATV). For embodiments of the invention where the vacuum unit is not within or directly adjacent to the animal litter to be cleaned, additional power must be supplied to the vacuum and/or blower motors to cause the animal litter to travel a greater distance through the inlet and outlet nozzles or to allow for greater volumes of animal litter to be cleaned. For example, it is contemplated that individual or combined vacuum/blower motors may even range up to between 100-300 HP for particular applications. However, those of ordinary skill in the art will be able to determine the vacuum and blower powers needed for a particular cleaning system configuration taking into account the lengths and dimensions of the hoses extending to and from the cleaning system, or the collective sizes of the blower, vacuum and shroud openings.

It is contemplated that embodiments of the invention may be used to clean animal litter for use within the region from which the litter originated, or for use in a different region. For example, a horse stall may be cleaned and the animal bedding returned to the cleaned stall as discussed above, or the cleaned bedding may be placed in a different stall in the same or a different horse stall complex. An embodiment of the invention may be configured with a large container or truck bed for storing and transporting cleaned animal litter for use elsewhere. It is also contemplated that used animal litter may be dropped-off by an animal owner or otherwise transported to a central location and then cleaned in bulk at that location for later re-use. There are many ways that animal litter may be re-used or otherwise recycled for use as animal litter or for other use through embodiments of the present invention.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method of cleaning animal litter, the method comprising removing contaminants from contaminated, absorbent animal litter through air vacuum pressure within a turbulence zone.

2. The method of claim 1, the method further comprising:
moving contaminated animal litter from a target area into suspension in an air stream;
removing contaminants from the suspended animal litter by the vacuum pressure; and
returning the animal litter to the target area.

3. The method of claim 1, wherein removing contaminants from contaminated litter through vacuum pressure within the turbulence zone comprises:
drawing the contaminated animal litter into a cyclonic separator chamber; and
separating the contaminants from the animal litter through cyclonic separation.

4. The method of claim 1, further comprising generating the turbulence zone to separate the animal litter from the contaminants by gravity separation.

5. The method of claim 1, further comprising destroying germs among the animal litter through exposing the animal litter to germicidal light.

6. A method of cleaning contaminated horse bedding, the method comprising:
removing contaminated horse bedding from a horse stall;
passing the contaminated horse bedding through an air stream;
separating contaminants from the horse bedding in the air stream.

7. The method of claim 6, wherein separating contaminants from the horse bedding comprises separating by cyclonic separation.

8. The method of claim 6, further comprising returning the horse bedding to the horse stall.

9. The method of claim 6, wherein suspending the contaminated horse bedding in the air stream comprises suspending horse bedding having a density greater than approximately 20 lb/ft³.

10. The method of claim 6, wherein suspending the contaminated horse bedding in the air stream comprises suspending horse bedding having a density of between approximately 20 lb/ft³ and approximately 70 lb/ft³.

11. The method of claim 6, wherein suspending the contaminated horse bedding in the air stream comprises suspending horse bedding having an LA Abrasion hardness value of less than approximately 40.

12. The method of claim 6, wherein suspending the contaminated horse bedding in the air stream comprises suspending horse bedding having an absorption capacity of approximately 0.5 ml/g to approximately 2.5 ml/g.

13. The method of claim 12, wherein suspending the contaminated horse bedding in the air stream comprises suspending horse bedding having an absorption capacity of approximately 1.4 ml/g to approximately 1.9 ml/g.

14. The method of claim 6, wherein suspending the contaminated horse bedding in the air stream comprises suspending horse bedding having an absorption rate in a 52 mm diameter column of approximately 90 milliliters or more within 10 minutes.

15. The method of claim 6, wherein suspending the contaminated horse bedding in the air stream comprises suspending horse bedding having a surface area greater than approximately 2,000,000 ft²/ft³.

16. The method of claim 6, further comprising destroying germs among the contaminated horse bedding by exposing the suspended horse bedding to germicidal light.

17. A method of cleaning absorbent animal litter having a predetermined density, the method comprising air vacuuming the animal litter with a sufficient vacuum force to remove contaminants from the animal litter but not remove the animal litter.

18. The method of claim 17, further comprising agitating the animal litter within a turbulence zone to enhance separation of the contaminants from the animal litter.

19. The method of claim 17, wherein the predetermined density is greater than approximately 20 lb/ft³.

20. The method of claim 17, further comprising creating a turbulence zone within an enclosed shroud through simultaneous blowing and vacuuming.

21. The method of claim 17, further comprising exposing the animal litter to a germicidal light.

22. A method of cleaning contaminated animal litter for reuse, the method comprising:
passing contaminated animal litter through an air stream;
separating contaminants from the animal litter in the air stream; and
destroying germs among the animal litter.

23. The method of claim 22, wherein destroying germs among the suspended animal litter comprises exposing the suspended animal litter to germicidal light.

24. The method of claim 22, wherein separating contaminants from the suspended litter comprises separating by gravity separation.

25. The method of claim 22, wherein separating contaminants from the suspended animal litter comprises separating within an enclosed shroud.

26. The method of claim 22, wherein separating contaminants from the suspended animal litter comprises separating using cyclonic separation.

27. An animal litter cleaning system comprising:
a first air pressure motor operating at a first power level and configured to generate a first air stream toward a turbulence zone;
a second air pressure motor operating at a second power level different from the first power level and configured to generate a second air stream away from the turbulence zone simultaneous with the first air pressure motor generating the first air stream toward the turbulence zone;
wherein simultaneous operation of the first and second air pressure motors generates air turbulence within the turbulence zone sufficient to separate contaminants from animal litter to draw the contaminants away from the turbulence zone in the second air stream, but allow the animal litter to separate from the air streams by gravity separation.

28. The animal litter cleaning system of claim 27, further comprising a germicidal light adjacent to the turbulence zone to expose the animal litter to energy from the germicidal light.

29. The animal litter cleaning system of claim 27, further comprising a shroud coupled to the cleaning system adjacent the turbulence zone such that the air turbulence is generated in part by the first air stream contacting the shroud.

30. The animal litter cleaning system of claim 29, wherein the shroud comprises a continuous perimeter around the turbulence zone and is open on a bottom side of the turbulence zone.

31. The animal litter cleaning system of claim 30, wherein a cross-sectional dimension size of the shroud is between approximately 2 to approximately 7 times larger than a combined cross-sectional dimension size of openings into the turbulence zone for the first and second air streams.

32. The animal litter cleaning system of claim 31, wherein the cross-sectional dimension size of the shroud is between approximately 3 to approximately 5 times larger than the combined cross-sectional dimension size of the openings into the turbulence zone for the first and second air streams.

33. An animal litter cleaning system comprising:
an intake nozzle;
an outlet nozzle;
a separation region between the intake nozzle and the outlet nozzle;
wherein the animal litter cleaning system is configured to draw contaminated animal litter from a target area into the separation region, separate contaminants from animal litter within the separation region by cyclonic separation, and return the animal litter to the target area through the outlet nozzle.

34. The animal litter cleaning system of claim 33, further comprising a germicidal light between the intake nozzle and the outlet nozzle, the germicidal light configured to destroy germs among the animal litter.

35. The animal litter cleaning system of claim 33, wherein the cyclonic separator is configured on a structure having wheels for portability between target areas.

36. The animal litter cleaning system of claim 35, wherein the wheels are wheels on a motorized vehicle.

37. The animal litter cleaning system of claim 33, wherein the cyclonic separator between the intake nozzle and the outlet nozzle is a first cyclonic separator, the system further comprising a second cyclonic separator in series with the first cyclonic separator and configured to further separate contaminants from the animal litter.

38. The animal litter cleaning system of claim 33, further comprising a first motor configured to draw contaminated animal litter into the system and a second motor configured to return cleaned animal litter to the target zone.
